(19) United States
(12) Patent Application Publication
(10) Pub. No.: US 2019/0364226 A1
(43) Pub. Date: Nov. 28, 2019

(54) DOT PROJECTOR AND METHOD FOR CAPTURING IMAGE USING DOT PROJECTOR

(71) Applicant: Sray-Tech LTD., Taipei City (TW)

(72) Inventor: Xun-Yu Zheng, Keelung City (TW)

(21) Appl. No.: 16/024,903

(22) Filed: Jul. 1, 2018

(30) Foreign Application Priority Data
May 24, 2018 (TW) 107117695

(51) Int. Cl. H04N 5/33; G02B 27/42; F21V 21/30

(52) U.S. Cl. CPC H04N 5/33; F21V 21/30; G02B 27/425

(57) ABSTRACT

The present invention provides a dot projector comprising a movable base, a light source emitter disposed above the movable base, a collimator, located in a front side of the light source emitter, a diffractive optical element (DOE) located in the front side of the light source emitter, and an actuator is connected to the movable base, the tilt angle of the movable base can be changed by providing a signal to the actuator.

### BACKGROUND OF THE INVENTION

### 1. Field of the Invention

The invention relates to the field of optics, in particular to a dot projector that can change the irradiation angle, and a method for capturing an image by the above dot projector.

### 2. Description of the Prior Art

With the advancement of science and technology, mobile phones have become one of the indispensable personal belongings of people. Therefore, the protection technology for personal mobile phone data has also been continuously researched and developed.

In recent years, with the development of 3D stereoscopic image sensing technology, electronic products with face recognition functions have gradually appeared on the market. Taking a mobile phone as an example, the mobile phones with face recognition function includes at least a flood illuminator, a dot projector and an infrared camera. The face recognition process of a mobile phone includes three steps in sequence: proximity sensing (determining whether an object approaches a mobile phone), flood illuminating sensing, and dot projecting sensing. It is worth noting that the method of sensing by the flood illuminator includes emitting a light source (e.g., infrared light) with a larger irradiation angle by the flood illuminator and projecting onto the surface of an object (e.g., a human face). Afterwards, the infrared light reflected from the object is received by the infrared camera, and then calculating by a processor or the like, roughly determines whether the object is a human face. When the object is determined to be a human face, the dot projector emits a plurality of light spots (for example, more than thousands or tens of thousands) projected onto the human face, and an infrared camera is used to receive the changing of the reflected light spot, to calculate the virtual face surface contour. It is used to accurately determine whether the detected face is the user of the mobile phone or other authenticated person.

A dot projector includes at least a light emitter and a diffractive optical element (DOE). After the light source generated by the light emitter passes through the diffractive optical element, multiple light spots will be generated to the objects or to the face. For the same diffractive optical element, the number of light spots that that producing per unit area is limited. If it is necessary to expand the detection range to recognize larger objects (e.g., environmental reproduction techniques), it is necessary to increase the projection angle (irradiation angle) of the dot projector. However, if a diffusion lens is used to amplify the irradiation angle of the dot projector directly, since the total irradiation energy is fixed, the energy of each light spot and the spot density in each unit area will be reduced correspondingly. And the infrared camera receives the reflected light spots, thereby reducing the accuracy of detecting and reconstructing the virtual object. On the other hand, if more high-precision diffractive optics are used (for example, more light spots can be produced per unit area), the overall production cost will also increase.

### SUMMARY OF THE INVENTION

The present invention provides a dot projector, the dot projector includes a movable base, a light source emitter disposed above the movable base, a collimator, located in a front side of the light source emitter, a diffractive optical element (DOE) located in the front side of the light source emitter, and an actuator, connected to the movable base, a tilt angle of the movable base can be changed by providing a signal to the actuator.

The present invention provides a method for capturing images using a dot projector, the method including: first, a dot projector is provided, the dot projector at least including: a movable base, an infrared camera located beside the movable base, a light source emitter disposed above the movable base, a collimator, located in a front side of the light source emitter, a diffractive optical element (DOE) located in the front side of the light source emitter, and an actuator, connected to the movable base, a tilt angle of the movable base can be changed by providing a signal to the actuator. Next, a light source is emitted by the light source emitter of the dot projector, and after the light source passes through the DOE, the DOE generates a plurality of light spots projected to a first part of an object, and each of the light spots is reflected by the object and then is detected by the infrared camera, the infrared camera is connected to a computing system to generate a first image, afterwards, the actuator is activated to adjust the tilt angle of the movable base, and another light source is emitted by the light source emitter of the dot projector after the tilt angle of the movable base is adjusted, and after the another light source passes through the DOE, the DOE generates a plurality of light spots projected to a second part of an object, and each of the light spots is reflected by the object and then is detected by the infrared camera, the infrared camera is connected to a computing system to generate a second image.

In the present invention, the dot projector is disposed on the movable base, and the tilt angle of the movable base can be adjusted by the actuator, so that the irradiation direction of the dot projector can be changed. When a larger object is detected and a larger irradiation angle is needed, the image can be segmented by scanning, and the segmented images are then integrated into a desired image in a computing system. As a result, it is not necessary to provide high-precision diffractive optical elements without reducing the detection precision, and the irradiation angle of the dot projector can still be enlarged.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic structural diagram of a dot projector according to the present invention.

FIG. 2 shows a schematic diagram of a method for capturing an image by using a dot projector proposed by the present invention.

### DETAILED DESCRIPTION

To provide a better understanding of the present invention to users skilled in the technology of the present invention, preferred embodiments are detailed as follows. The preferred embodiments of the present invention are illustrated in the accompanying drawings with numbered elements to clarify the contents and effects to be achieved.

Please note that the figures are only for illustration and the figures may not be to scale. The scale may be further modified according to different design considerations. When referring to the words “up” or “down” that describe the relationship between components in the text, it is well known in the art and should be clearly understood that these words refer to relative positions that can be inverted to obtain a similar structure, and these structures should therefore not be precluded from the scope of the claims in the present invention.

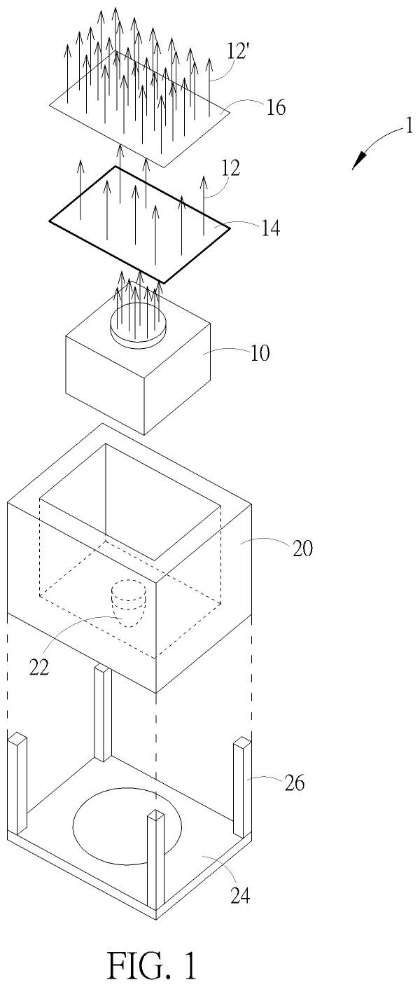

Please refer to FIG. 1, which is a schematic cross-sectional view diagram of a dot projector of the present invention. As shown in FIG. 1, the dot projector 1 of the present invention includes a light source emitter 10. Here, the direction of the light source (for example, visible light, infrared ray, etc.) emitted by the light source emitter 10 is defined as a front side. A light source 12 is emitted toward the front side of the light source emitter 10, and a collimator 14 and a diffractive optical element (DOE) 16 are disposed along the front side of the light source 12. In other words, when the light source 12 is emitted by the light source emitter 10, it will pass through the collimator 14 and the DOE 16 in sequence. The light source 12 is preferably laser light, but it is not limited thereto. The main function of the collimator 14 is to converge the light emitted in different directions into parallel light, and when the parallel light source (i.e., the light source 12 after passing through the collimator 14) passes through the diffractive optical element 16, multiple light spots will be generated (for example, thousands or tens of thousands of light spots 12′. The light spots are projected onto an object (such as a human face) and reflected, and an infrared camera is used to receive the changing of the reflected light spots to calculate a virtual face contour and compare with the authenticated face information.

In addition, the light source emitter 10 is disposed on a movable base 20. The movable base 20 includes a transmission support structure 22. Therefore, the movable base 20 can be tilted or be rotated within a certain range by the transmission support structure 22. An actuator 24 is disposed below the movable base 20. In the present invention, the actuator 24 may be an electronic control device such as a voice coil motor (VCM) , a micro-electro-mechanical system (MEMS) or a shape memory alloys (SMA) or the like, but the actuator 24 of the present invention is not limited thereto, and other devices that can generate structural changes by signal control can also be applied to the actuators of the present invention. . The actuator 24 is connected to a control chip (not shown), and the control chip sends a signal to control the actuator 24, so as to change the tilt angle of the movable base 20. In more detail, taking the present embodiment as an example, the actuator 24 includes a voice coil motor that includes four support pins 26 in which each support pin 26 can be controlled to extend or shorten respectively. Therefore, when one specific support pin 26 is extended, the movable base 20 is pushed to cause tilting of the movable base 20 (for example, when the right support pin 26 is extended, the movable base 20 may be inclined to the left). Besides, the movable base 20 of the present invention may not only be inclined toward a single direction (for example, a horizontal direction) but also may be inclined toward to different directions (for example, a vertical direction). Therefore, by controlling the actuator 24, the irradiation angle of the light source emitter 10 on the movable base 20 can also be changed according to requirements. In other words, the irradiation angle of the light source emitter 10 can be increased by tilting the movable base 20. When it is necessary to enlarge the irradiation angle of the dot projector to detect a large object (such as environmental reproduction), the dot projector can scan through all the areas of the large object in this manner by means of scanning.

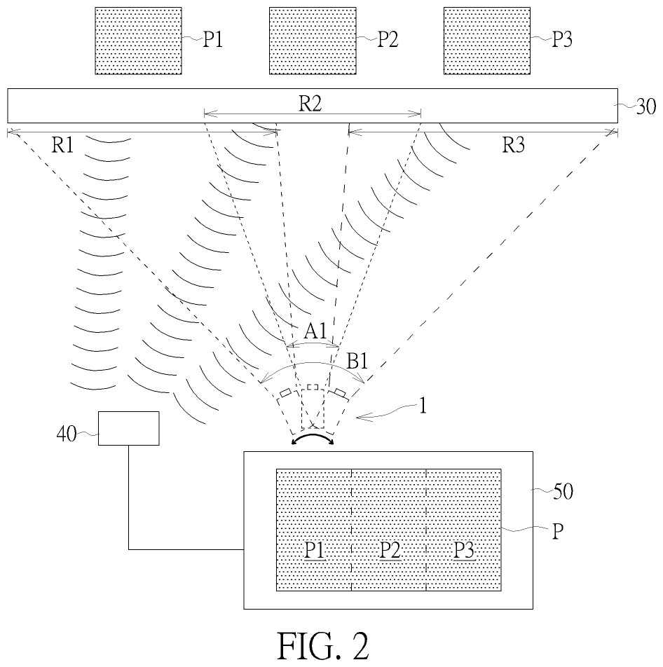

FIG. 2 shows a schematic diagram of a method for capturing an image by using the dot projector 1 proposed by the present invention. First, a dot projector 1 is provided. Here, the dot projector 1 is the dot projector shown in FIG.1. It is characterized in that it includes a movable base and an actuator, so that the irradiation angle of the dot projector 1 can be changed as required. Then, an object 30 is provided, where the object 30 is assumed to be a relatively large object, so that the range of the object 30 is beyond the irradiation angle of the original dot projector 1 (for example, in this embodiment, the maximum illumination angle of the fixed dot projector 1 is 70 degrees) At this time, the irradiation angle of the dot projector 1 is controlled to sequentially scan different ranges of the object 30. For example, in the present embodiment, the object 30 is divided into the region R1, the region R2, and the region R3, and the dot projector 1 sequentially scans the above-mentioned region R1, region R2 and region R3. The region R1, the region R2, and the region R3 may partially overlap each other or do not overlap each other. After the dot projector 1 emits a plurality of light spots and projects to the region R1, the changing of the light spots reflected by the region R1 is received by the infrared camera 40, and the infrared camera 40 is connected to a computing system 50. Here, the light spot changing image reflected by the region R1 and received by the infrared camera 40 is defined as P1. Similarly, after the dot projector 1 emits a plurality of light spots projected to the region R2, the light spot changing reflected by the region R2 is received by the infrared camera 40 too. The light spots changing image is defined as P2. After the dot projector 1 emits a plurality of light spots projected to the region R3, the light spot changing reflected by the region R3 is received by the infrared camera 40, where the light spot changing image reflected by the region R3 and received by the infrared camera 40 is defined as P3. The three light spot changing images P1, P2, P3 are respectively stored in the computing system 50, and then the computing system 50 integrates the light spot changing images P1, P2, P3 into a final (complete) light spot changing image P, and according to the final light spot changing image P, reconstruct a virtual object contour. The dot projector 1 provided by the present invention can significantly increase the sum of the illumination angle compared to the conventional dot projectors. Taking the present embodiment as an example, if the dot projector 1 is fixed, the total irradiation angle A1 is about 70 degrees, and by scanning method, the irradiation angle B1 can be increased more than 100 degrees.

In addition, the dot projector 1 shown in FIG. 2 scans only along a single direction (for example, horizontal direction), but in other embodiments of the present invention, scanning in different directions may be performed at the same time, for example, horizontally and vertically. Scanning along different directions can further enlarge the irradiation angle of the dot projector, which also belongs to the scope of the present invention.

In the present invention, the dot projector is formed on the movable base, so the dot projector can detect large objects by scanning, and at the same time, since the numbers of the light spots in per unit illumination area does not decreased, so the accuracy of the dot projector will not be decreased too. More precisely, conventional dot projectors can only irradiate a fixed angle, if it is necessary to accurately detect an object (such as a human face) , a high-precision optical element is required. For example, when a light source passes through a diffractive optical element, it needs to generate approximately 30,000 light spots, to accurately determine the face contour. Compared with the conventional dot projector, the present invention can replace the high-price and high-precision diffractive optical elements with a low-price and lower-precision diffractive optical element. For example, when the light source passes through the diffractive optical element, it only needs to be generated about 1,000 to 10,000 light spots. Taking this embodiment as an example, the number of light spots generated after the light source passes through the diffractive optical element is less than 10,000, and even less than 5,000 light spots. With the scanning method, the purpose of detecting a complete object can still be achieved. Therefore, it is not necessary to produce a highly accurate diffractive optical element, the overall production cost can also be reduced.

In summary, the present invention is characterized in that the dot projector is disposed on the movable base, and the angle of the movable base can be adjusted by the actuator, so that the irradiation direction of the dot projector can be changed. When it is necessary to expand the irradiation angle to detect a large object, the image can be segmented and extracted by using a scanning method, and the image of each segment can be integrated into a desired image in the computing system. In this way, the detection precision can be maintained, and it is not necessary to provide a high-precision diffractive optical elements, the irradiation angle of the dot projector can still be enlarged.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dot projector, comprising:
a movable base;
a light source emitter disposed above the movable base;
a collimator, located in a front side of the light source emitter;
a diffractive optical element (DOE) located in the front side of the light source emitter; and
an actuator, connected to the movable base, wherein a tilt angle of the movable base can be changed by providing a signal to the actuator.

2. The dot projector of claim 1, wherein the actuator comprises a voice coil motor (VCM), a micro-electro-mechanical system (MEMS) or a shape memory alloy (SMA).

3. The dot projector of claim 1, wherein an adjustable tilt angle of the movable base is greater than 100 degrees.

4. The dot projector of claim 3, wherein the direction of the adjustable angle of the movable base includes the horizontal direction and the vertical direction.

5. The dot projector of claim 1, wherein the light source emitter emits a light source, and the light source generates a plurality of light spots after passing through the diffractive optical element, wherein the number of light spots is less than 10,000.

6. The dot projector of claim 1, wherein the movable base includes a transmission support structure.

7. A method for capturing images using a dot projector, comprising:
providing a dot projector, wherein the dot projector at least including:
a movable base;
an infrared camera located beside the movable base;
a light source emitter disposed above the movable base;
a collimator, located in a front side of the light source emitter;
a diffractive optical element (DOE) located in the front side of the light source emitter; and
an actuator, connected to the movable base, the tilt angle of the movable base can be changed by providing a signal to the actuator;
emitting a light source by the light source emitter of the dot projector, and after the light source passes through the DOE, the DOE generates a plurality of light spots projected to a first part of an object, and each of the light spots is reflected by the object and then is detected by the infrared camera, the infrared camera is connected to a computing system to generate a first image;
activating the actuator to adjust the tilt angle of the movable base; and
emitting another light source by the light source emitter of the dot projector after the tilt angle of the movable base is adjusted, and after the another light source passes through the DOE, the DOE generates a plurality of light spots projected to a second part of an object, and each of the light spots is reflected by the object and then is detected by the infrared camera, the infrared camera is connected to a computing system to generate a second image.

8. The method of claim 7, wherein the computing system combines the first image with the second image and generates a final image.

9. The method of claim 7, wherein the first part of the object and the second part of the object partially overlap each other.

10. The method of claim 7, wherein the first part of the object and the second part of the object do not overlap each other.

11. The method of claim 7, wherein the actuator comprises a voice coil motor (VCM), a micro-electro-mechanical system (MEMS) or a shape memory alloy (SMA).

12. The method of claim 7, wherein an adjustable tilt angle of the movable base is greater than 100 degrees.

13. The method of claim 7, wherein the light source emitter emits a light source, and the light source generates a plurality of light spots after passing through the diffractive optical element, wherein the number of light spots is less than 10,000.

14. The method of claim 7, wherein the movable base includes a transmission support structure.
